(19) United States
(12) Patent Application Publication
(10) Pub. No.: US 2010/0115438 A1
(43) Pub. Date: May 6, 2010

(54) METHOD FOR CREATING MULTI-LEVEL WIDGETS AND SYSTEM THEREOF

(76) Inventor: Yu-Chung Chu, Great Falls, VA (US)

Correspondence Address: NIKOLAI & MERSEREAU, P.A., 900 SECOND AVENUE SOUTH, SUITE 820, MINNEAPOLIS, MN, 55402, US

(21) Appl. No.: 12/265,259

(22) Filed: Nov. 5, 2008

(51) Int. Cl. G06F 3/048

(52) U.S. Cl. 715/764

(57) ABSTRACT

A method for creating multi-level widgets and a system thereof are provided. The method includes the steps of: embedding intended widgets in a platform having a software application programming interface; determining whether at least a widget is to be embedded in the widgets embedded; determining whether at least a widget is to be further embedded in the widgets embedded; and forming multi-level widgets by embedding more of the widgets in the widgets embedded, respectively, so as to enable multi-level editing.

### BACKGROUND OF THE INVENTION

1. Field of the Invention

The present invention relates to a method for a widget and a system thereof, and more particularly, to a method for creating multi-level widgets and a system thereof.

2. Description of the Prior Art

Owing to the burgeoning information on the Internet, the Internet has become indispensable to daily life of human beings nowadays, allowing people to access the Internet in order to fetch, at any time, medium information, such as news, messages posted by users, and shared video and music.

A lot of people get connected to a server end, using an Internet link, to access works (for example, diaries or essays) posted, audio/video information shared, and news published on homepages (for example, blogs) hosted by a shared Internet platform. However, to edit essays or share audio/video/news related information on their blogs, user ends have to be experienced in intricate procedure of essay editing and audio/video/news sharing, which is rather inconvenient and time-consuming to the user ends.

Conventional blogs allow a user end to either edit an essay/picture or play audio/video information (i.e., video and sound) on a single displayed webpage. For instance, a user end editing an essay on a webpage of a blog is unable to load (embed) audio/video information in the webpage, and in consequence it is impossible to display the essay and play audio/video information on the same webpage concurrently. Also, to load audio/video information in a webpage of a blog, the user end has to search laboriously for the path of a saved audio/video file before uploading the located audio/video file to the blog to be played thereon and viewed by the user end.

On the other hand, although user ends enjoy ease of reading by skimming through or clicking on an e-book available for reading on a webpage of an existing blog, a drawback of the prior art remains unsolved—a single webpage on a blog cannot display a plurality of essays and play a plurality of pieces of audio/video information concurrently. Hence, the prior art is intricate, inconvenient, and time-consuming in terms of editing performed on the part of a user end or a sharing end. In short, the prior art has the following drawbacks:
1. Editing is time-consuming.
2. Editing is slow, intricate, and inconvenient.
3. Media information cannot be displayed and operated on the same webpage.

Accordingly, the inventor of the present invention and related manufacturers are faced with a problem that calls for immediate solution, namely the aforesaid drawbacks of the prior art.

### SUMMARY OF THE INVENTION

To solve the aforesaid problem efficiently, it is a primary objective of the present invention to provide a method for creating multi-level widgets with a multi-level editing structure, and a system of the same.

Another objective of the present invention is to provide a method for creating multi-level widgets conducive to simple, convenient, and quick editing, and a system of the same.

Yet another objective of the present invention is to provide a method for creating multi-level widgets for enhancing promotion-based marketing, and a system of the same.

A further objective of the present invention is to provide a method for creating multi-level widgets so as to render editing and creation time-efficient, and a system of the same.

A further objective of the present invention is to provide a method for creating multi-level widgets so as to display and operate a variety of multimedia information within the same window, and a system of the same,

To achieve the above and other objectives, it is an objective of the present invention to provide a method for creating multi-level widgets, comprising the steps of: embedding intended widgets in a platform having a software application programming interface; determining whether at least one said widget is to be embedded in the widgets embedded; determining whether at least one said widget is to be further embedded in the widgets embedded; and forming multi-level widgets by embedding more said widgets in the widgets embedded, respectively, so as to enable multi-level editing.

Another objective of the present invention is to provide a system for creating multi-level widgets, comprising: a platform means equipped with a software application programming interface and configured for coupling a platform and a widget embedded in a webpage of the platform; a widget means for sending, upon receipt of event related information, list related parameters of widgets embedded to the widgets, so as to enable the widgets to start operation; and an operation means operated by a user end to determine whether more said widgets are to be embedded in the platform.

Features and technical disclosures of the present invention will be best understood by reference to the following detailed description of the present invention and the accompanying drawings. However, the accompanying drawings are only to be used as references and illustrations but are not intended to limit the present invention,

### BRIEF DESCRIPTION OF THE DRAWINGS

The invention as well as a preferred mode of use, further objectives and advantages thereof will be best understood by referring to the following detailed description of an illustrative embodiment in conjunction with the accompanying drawings, wherein:

FIG. 1 is a flow chart of the present invention;

FIG. 2 is a schematic view of multi-level widgets of the present invention;

FIG. 3 is a block diagram of the widgets of the present invention; and

FIG. 4 is a flow chart of display in a preferred embodiment of the present invention.

### DETAILED DESCRIPTION OF THE EMBODIMENT

The aforesaid objectives, structural features, and functional features of the present invention will be best understood by reference to the following detailed description of the preferred embodiment when read in conjunction with the accompanying drawings.

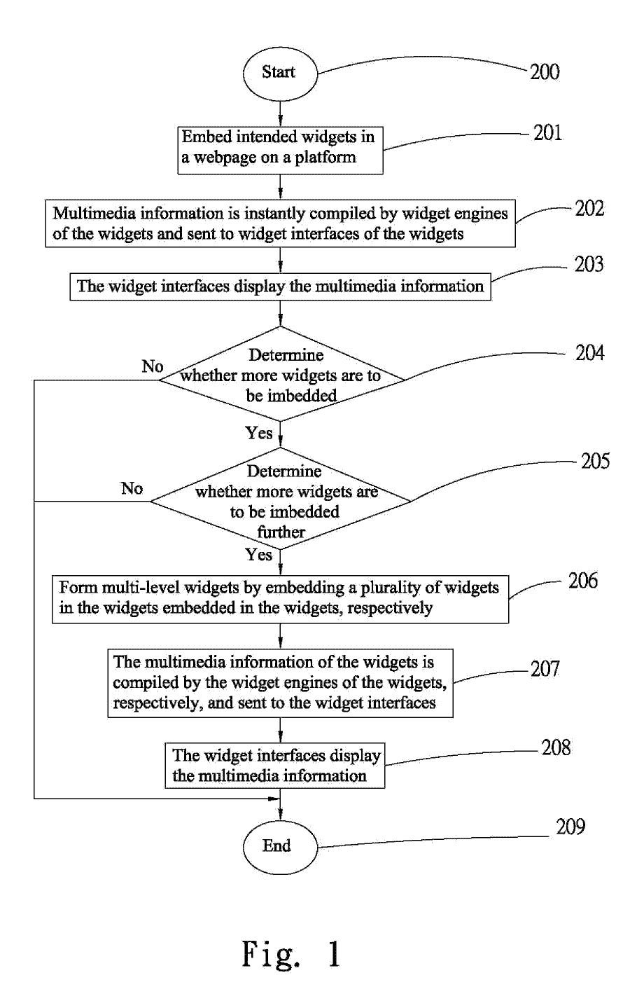

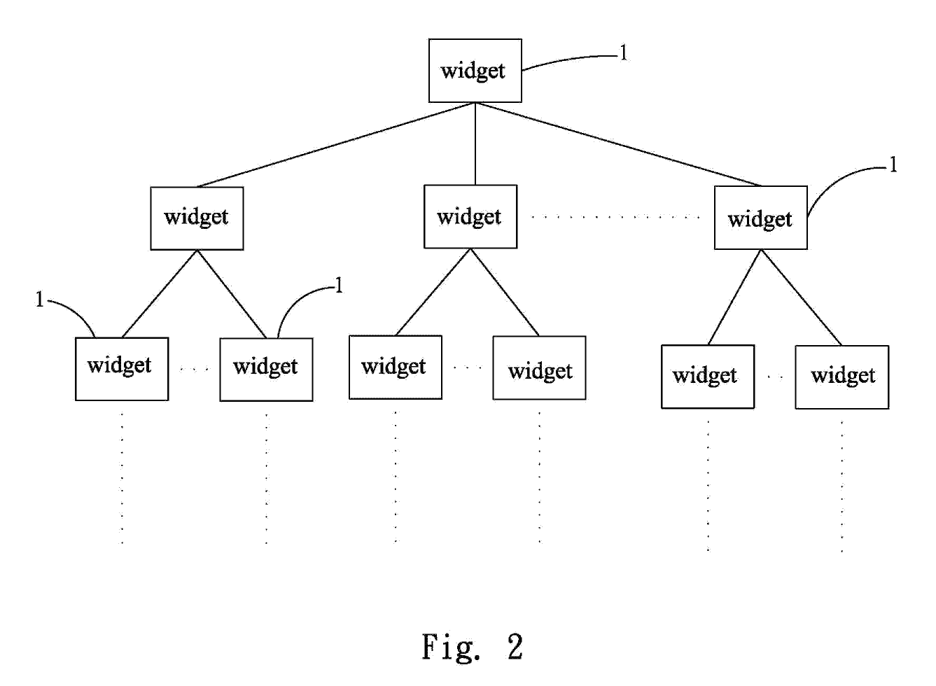

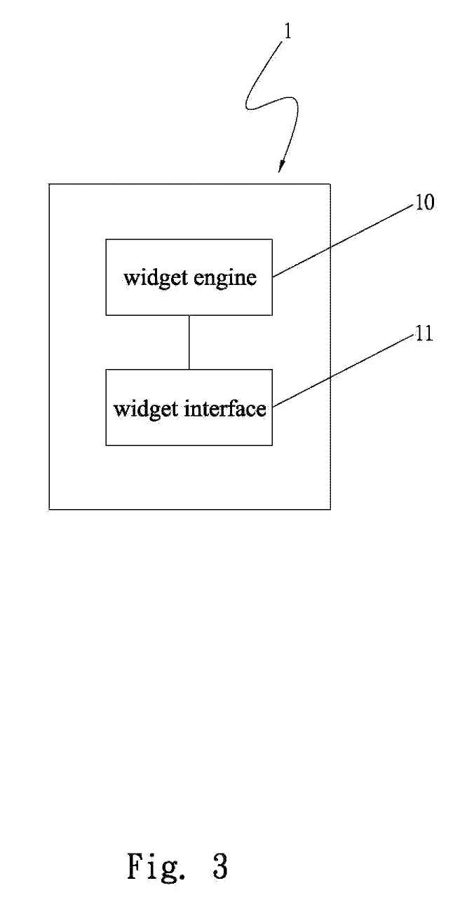

Referring to FIGS. 1, 2 and 3, the present invention is directed to a method for creating multi-level widgets and a system thereof, and in a preferred embodiment of the present invention, a plurality of widgets are built (or stored) on a platform having a software application programming interface. The platform is a web browser, an operating system platform (for example, Microsoft Windows, or Apple's Mac OS), or a mobile device (for example, cell phones, PDA, or iPhone). The software application programming interface, which is an application programming interface (API), a software development kit (SDK), or a launch pad, functions as a communication interface between two applications and/or between an application and a database.

Provided in the preferred embodiment of the present invention are a plurality of widgets 1 which are application programs to be executed independently, and each of the widgets 1 extends downward or is loaded with at least a widget 1 (also known as a child widget) so as to form multi-level widgets; in other words, the multi-level widgets are generally tree-structured. Each of the widgets 1 is embedded with a plurality of said widgets 1, and then original said widgets 1 (also known as parent widgets) which are embedded/loaded with other said widgets 1 are embedded in a webpage of the platform (for example, a web browser) for integration purpose, so as for a variety of multimedia information to be displayed within the same window efficiently.

The widgets 1 each have a widget engine 10 and a widget interface 11. The widget engine 10 is configured to compile and process a variety of multimedia information of the widget interfaces 11 loaded. The multimedia information is computed and converted with the program code of the application program before being sent to the widget interfaces 11 (i.e., parent widget interfaces) at the bottom. The widget interfaces 11 at the bottom enable a variety of multimedia information of the widget interfaces 11 (i.e., child widget interfaces 11 embedded/loaded in the parent widget interfaces 11) to be displayed on a webpage within the same window. The multimedia information comprises video, sound, pictures, animation, text, games, advertisement, etc.

A point worthy of note is that the widgets enable real-time interaction. For instance, where multimedia information of the widgets is interactive video, user ends can have video chat through the widget interfaces, which is more convenient and time-saving than the disclosure in the prior art; the prior art taught opening a video window through a video software interface in order to have video chat within the video window. The multimedia information includes interactive video, interactive chat rooms, interact games, etc.

Information carried by the multimedia information of each of the widget interfaces 11 is executed separately. For instance, a parent widget interface 11 is embedded with three child widget interfaces 11 therein, and multimedia information of the child widget interfaces 11 is presented in the form of video files (e.g., a movie), e-map (Google Maps), or audio files (e.g., music). To use or watch one of the widget interfaces 11, all a user end needs to do is to execute the one of the widget interfaces 11 only and watch. Further description of the above-mentioned disclosure is exemplified by an e-map of the widget interfaces 11 hereunder.

To use Google Maps in a known manner, a user end gets connected to the Google Homepage, clicks on the icon of Google Maps, and searches for the location of a specific place (for example, an address, a road, a scenic spot, etc.). By contrast, in the preferred embodiment of the present invention works, an e-map of a widget interface is connected to Google Maps by a hyperlink and displayed on the widget interface, allowing any e-map of a specific location to be directly displayed on a widget interface and further operated (for example, zoomed in and out or moved around) on the widget interface; hence, a user end can gain access to voluminous, diverse multimedia information displayed within the same window with ease of use, thereby enhancing advertisement or promotion-based marketing.

Referring to FIG 1, which is a flow chart of a method for creating multi-level widgets according to the present invention, the method comprises the following steps:
(200) Start
(201) Embed intended widgets 1 in a webpage on the platform (for example, the web browser).
(202) Widget engines 10 of the widgets 1 perform compilation instantly, allowing multimedia information to be sent to widget interfaces 11 of the widgets 1.
(203) The widget interlaces 11 display the multimedia information to be used or viewed.
(204) Determine whether more widgets 1 are to be embedded (in other words, a user end determines whether editing is to continue and whether more multimedia information is to be created). Go to step 205 in response to an affirmative determination. Go to step 209 in response to a negative determination.
(205) Embed a plurality of widgets 1 in the widgets 1 and determine whether more widgets 1 are to be embedded in the widgets 1 (in other words, determine whether editing is to continue and whether more multimedia information is to be created). Go to step 206 in response to an affirmative determination. Go to step 209 in response to a negative determination.
(206) Form multi-level widgets by embedding more said widgets in the widgets embedded, respectively.
(207) Multimedia information of the widgets 1 is compiled by the widget engines 10 of the widgets 1, respectively, and sent to the widget interfaces 11.
(208) The widget interfaces 11 display the multimedia information to be used and viewed, allowing editing and a creation process to be carried out in an easy, quick, and time-saving manner.
(209) End

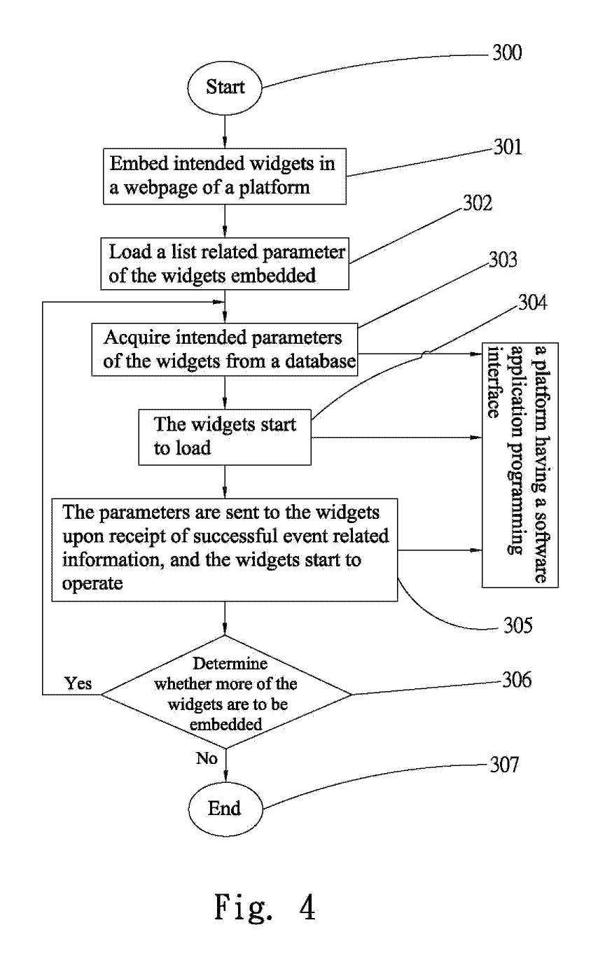

FIG. 4 is a flow chart of display in a preferred embodiment of the present invention. Referring to FIGS. 1, 2 and 4, a user end's editing and creating (for example, editing books, sharing audio/video information, or writing essays) on a platform having a software application programming interface (API), using the aforesaid method, further comprises the following steps:
(300) Start
(301) Embed Intended widgets 1 in a webpage of the platform (for example, the web browser).
(302) Select and load a list related parameter of the widgets 1 embedded from a webpage on the API; Edit the list related parameter according to the number of the widgets 1 to be edited on a single webpage being edited by a user end, for example, a list related parameter of three widgets 1 is embedded when three widgets 1 are required for a first webpage, and a list related parameter of five widgets 1 is embedded when five widgets 1 are required for a second webpage, and so forth, thereby allowing each webpage to have at least a list related parameter.
(303) Link the webpage of the API to a database; acquire intended parameters of the widgets 1 from the database; load the parameters on the webpage of the API; send the parameters to the widgets; the database comprises a parameter selected from the group consisting of position, dimension, session, user info, and merchandize or content setup, wherein a position parameter, for example, represents the position of the widgets 1, that is, coordinates (x, y) of the widgets 1.
(304) The widgets 1 start to load; take widgets 1 of YouTube (i.e., audio/video information) as example, the widgets 1 start to load video tiles from YouTube.
(305) The parameters are sent to the widgets 1 upon receipt of successful event related information by the webpage of the API; the parameters are received and compiled by the widget engines 10 of the widgets 1; the widgets 1 start to operate; and the widget interfaces 11 display multimedia information to be used and viewed.
(306) Determine, according to the setting at the user end, whether more of the widgets 1 are to be embedded. Return to step 303 in response to an affirmative determination. Go to step 307 in response to a negative determination.
(307) End

The system comprises: a platform means equipped with a software application programming interface and configured for coupling a platform and a widget embedded in a webpage of the platform, wherein the platform means is implemented by the aforesaid platform, such as a web browser, an operating system platform (for example, Microsoft Windows, or Apple's Mac OS), or a mobile device (for example, cell phones, PDA, or iPhone); a widget means for sending, upon receipt of event related information, list related parameters of widgets embedded to the widgets, so as to enable the widgets to start operation; and an operation means operated by a user end to determine whether more said widgets are to be embedded in the platform.

The widgets comprise: an editing engine for compiling multimedia information means of the widgets loaded; and a widget interface for displaying and executing the multimedia information means of different types within a same window webpage.

In conclusion, the present invention is directed to a method for creating multi-level widgets, which has the following advantages:
1. A variety of multimedia information can be displayed and operated within the same window.
2. Time-efficient editing.
3. Easy, convenient, and quick editing.
4. Enhanced effects of advertisement and promotion.

In an embodiment of the present invention, the method of the present invention involves using a computer program product. The computer program product should have all the features and characteristics required for implementation of the method described in the specification. With the computer program product, the method of the present invention is implemented upon execution of the computer program loaded to the platform equipped with a software application programming interface.

The method further comprises using a computer-readable recordable medium. The computer-readable recordable medium is stored with a computer program for executing the aforesaid steps with a computer. The computer-readable recordable medium is a floppy disk, a hard disk, a CD-ROM, a flash drive, a magnetic tape, an Internet-accessible database, or any storage medium readily conceivable by persons skilled in the art and characterized by equivalent functions.

The foregoing preferred embodiment is only illustrative of the features and functions of the present invention but is not intended to restrict the scope of the present invention. Changes and modifications within the field of the present invention and readily conceivable to persons skilled in the art should fall within the scope of the appended claims of the present invention.

What is claimed is:

1. A method for creating multi-level widgets, comprising the steps of:
selecting and loading a list related parameter of the widgets embedded from a webpage on a platform having a software application programming interface;
linking the platform to a database, acquiring intended parameters of the widgets from the database, sending the parameters to the webpage on the platform, and sending the parameters from the webpage on the platform to the widgets;
allowing the widgets to start loading, sending the parameters to the widgets upon receipt of event related information by the platform, so as to enable the widgets to start operation and display multimedia information;
determining whether at least one said widget is to be embedded in the widgets embedded;
determining whether at least one said widget is to be further embedded in the widgets embedded; and
forming multi-level widgets by embedding more said widgets in the widgets embedded, respectively, so as to enable multi-level editing.

2. The method of claim 1, wherein editing terminates upon determination that the widgets embedded are not to be embedded with a said widget.

3. The method of claim 1, wherein editing continues upon determination that the widgets embedded are to be embedded with a said widget.

4. The method of claim 1, wherein the platform is one selected from the group consisting of a web browser, an operating system platform, and a mobile device.

5. The method of claim 1, wherein the software application programming interface is one of an application programming interface (API) and a software development kit (SDK).

6. The method of claim 1, wherein the multi-level widgets are generally tree-structured.

7. The method of claim 1, wherein the database comprises a parameter selected from the group consisting of position, dimension, session, user info, and merchandize or content setup.

8. The method of claim 1, wherein the multimedia information comprises information selected from the group consisting of video, sound, pictures, animation, text, games, and advertisement.

9. The method of claim 1, wherein the multimedia information further comprises information selected from the group consisting of interactive video, interactive chat rooms, and interact games.

10. A computer program product having memory for use in creation of multi-level widgets and allowing the method of claim 1 to be implemented when the computer program is loaded on a platform having a software application programming interface and executed.

11. A computer-readable recordable medium having program code for use in creation of multi-level widgets and allowing the method of claim 1 to be implemented when the program is loaded on a computer and executed.

12. A system for creating multi-level widgets, comprising:
a platform means equipped with a software application programming interlace and configured for coupling a platform and a widget embedded in a webpage of the platform;
a widget means for sending, upon receipt of event related information, list related parameters of widgets embedded to the widgets, so as to enable the widgets to start operation; and
an operation means operated by a user end to determine whether more said widgets are to be embedded in the platform.

13. The system of claim 12, wherein the widgets comprise:
an editing engine for compiling multimedia information means of the widgets loaded; and
a widget interface for displaying and executing the multimedia information means of different types within a same window webpage.
